(19) United States
(12) Patent Application Publication
(10) Pub. No.: US 2025/0291210 A1
(43) Pub. Date: Sep. 18, 2025

(54) OPTICAL PULSE SOURCE, OPTICAL SYSTEM FOR RYDBERG EXCITATION AND METHOD OF FORMING OPTICAL PULSES

(71) Applicant: NKT Photonics A/S, Birkerød (DK)

(72) Inventors: Asger Sellerup JENSEN, Birkerød (DK); Jens Engholm PEDERSEN, Birkerød (DK)

(73) Assignee: NKT Photonics A/S, Birkerød (DK)

(21) Appl. No.: 18/860,345

(22) PCT Filed: Apr. 28, 2023
(86) PCT No.: PCT/EP2023/061336

§ 371 Date: Oct. 25, 2024

(30) Foreign Application Priority Data
Apr. 28, 2022 (EP) 22170537.9

(51) Int. Cl. G02F 1/01; G02F 1/35; G02F 1/37; H01S 3/00

(52) U.S. Cl. CPC G02F 1/0121; G02F 1/3534; G02F 1/37; H01S 3/0085; G02F 2203/50

(57) ABSTRACT

An optical pulse source including: a first laser configured to output laser light at a first wavelength; a second laser configured to output laser light at a second wavelength; optical modulation apparatus configured to apply amplitude modulation to a first one of the laser light at the first wavelength or the laser light at the second wavelength to form first laser light pulses; optical amplification apparatus configured to amplify the first laser light pulses and a second one of the laser light at the first wavelength or the laser light at the second wavelength; and optical frequency conversion apparatus configured to perform optical frequency conversion using the first laser light pulses and the second one of the laser light at the first wavelength or the laser light at the second wavelength to form output laser light pulses at a third wavelength, shorter than the first wavelength and the second wavelength.

### TECHNICAL FIELD

The invention relates to an optical pulse source and to a method of generating optical pulses. The invention further relates to an optical system for Rydberg excitation.

### BACKGROUND

Generation of optical pulses at wavelengths at which lasers cannot directly generate laser light, for example at ultraviolet, UV, wavelengths, is known to be performed by generating continuous wave, cw, laser light at high optical power, then frequency converting the high power cw laser light to the desired output wavelength and amplitude modulating the frequency converted cw laser light to form output optical pulses, having a lower peak optical power. US 2007/064749 A1 describes an alternative approach for generation of deep UV laser pulses using directly modulated semiconductor lasers to generate laser pulses, which are then amplified and frequency converted to generate laser pulses at around 198 nm.

### SUMMARY

A first aspect provides an optical pulse source comprising a first laser, a second laser, optical modulation apparatus, optical amplification apparatus and optical frequency conversion apparatus. The first laser is configured to output laser light at a first wavelength. The second laser is configured to output laser light at a second wavelength, different to the first wavelength. The optical modulation apparatus is configured to apply amplitude modulation to a first one of the laser light at the first wavelength or the laser light at the second wavelength to form first laser light pulses. The optical amplification apparatus is configured to amplify the first laser light pulses and a second one of the laser light at the first wavelength or the laser light at the second wavelength. The optical frequency conversion apparatus is configured to perform optical frequency conversion using the first laser light pulses and the second one of the laser light at the first wavelength or the laser light at the second wavelength to form output laser light pulses at a third wavelength. The third wavelength is shorter than the first wavelength and the second wavelength.

By forming the first laser light pulses prior to optical frequency conversion the optical pulse source may enable more power efficient output pulse generation than systems which form output pulses from cw laser light following optical frequency conversion to a desired third (output) wavelength. The optical pulse source may therefore form output pulses of a desired pulse peak power using lower average optical powers than is required for systems which form output pulses from cw laser light following optical frequency conversion. Advantageously, inter pulse noise is efficiently supressed during optical frequency conversion of the first laser light pulses into the output laser light pulses.

In an embodiment, the optical modulation apparatus comprises a first optical modulator configured to apply amplitude modulation to one of the laser light at the first wavelength or the laser light at the second wavelength to form the first laser light pulses. Use of an external optical modulator enables amplitude modulation of a desired form to be applied, to form first laser light pulses of a desired shape.

In an embodiment, the optical modulation apparatus further comprises a second optical modulator. The first optical modulator is configured to apply amplitude modulation to the laser light at the first wavelength to form the first laser light pulses at the first wavelength. The second optical modulator is configured to apply amplitude modulation to the laser light at the second wavelength to form second laser light pulses at the second wavelength. Use of external optical modulators enables amplitude modulation of a desired form to be applied to the laser light, to form first and second laser light pulses of a desired shape.

One advantage of using a modulation apparatus to modulate the laser light at the first and/or second wavelength to form the laser light pulses is that a wide range of modulation profiles can be applied to the formed laser pulses. The pulse modulation can e.g. be optimized to compensate for down-stream shape perturbations of the of the laser light pulses introduced by the optical amplification apparatus and/or the optical frequency conversion apparatus. Optical amplifiers typically have a non-uniform gain response in the time domain, caused by inversion depletion in the optical amplifier gain medium that occurs as a pulse propagates through the gain medium. By reducing the pulse intensity at the leading edge of the pulse relative to the trailing edge, the decreasing amplification across the pulse can be compensated. In prior art systems where the laser light pulses are delivered directly from first and second lasers, e.g. by directly modulated semiconductor lasers, the modulation of the lasers, and hence the pulse modulation capabilities, is limited and is not sufficient to compensate for these shape perturbations.

In an embodiment, the optical amplification apparatus comprises a first optical amplifier configured to amplify the first laser light pulses and a second optical amplifier configured to amplify the second laser light pulses.

In an embodiment, the optical amplification apparatus is configured to be continuously pumped. Continuously pumping the optical amplification apparatus advantageously causes energy to build up within the optical amplification apparatus between pulses, which enables the optical amplification apparatus to amplify the first laser light pulses to have a high pulse peak power while pumping the optical amplification apparatus to amplify to a relatively low average power.

In an embodiment, the optical pulse source further comprises output pulse control apparatus comprising an optical detector and a controller. The optical detector is configured to detect a pulse shape of a laser light pulse and to generate an output signal indicative of the detected pulse shape. The controller comprises interface circuitry, at least one processor and memory comprising instructions executable by said processor whereby the controller is operative as follows. The controller is operative to receive an output signal indicative of a detected pulse shape from the optical detector. The controller is operative to determine a difference between the detected pulse shape and a target pulse shape. The controller is operative to determine a compensating pulse shape for the first laser light pulses. The compensating pulse shape configured to at least partly compensate for the difference between the detected pulse shape and the target pulse shape. The controller is operative to generate at least one drive signal for the optical modulation apparatus. The at least one drive signal is configured to cause the optical modulation apparatus to apply amplitude modulation to form first laser light pulses having the compensating pulse shape.

Forming the first laser light pulses having a compensating pulse shape may enable the optical pulse source to compensate for pulse shape perturbations introduced by the optical amplification apparatus and/or the optical frequency conversion apparatus, which may advantageously enable the optical pulse source to form output laser light pulses having a target pulse shape independent of such pulse shape perturbations.

In an embodiment, the optical modulation apparatus comprises a first optical modulator and a second optical modulator. The first optical modulator is configured to apply amplitude modulation to the laser light at the first wavelength to form the first laser light pulses at the first wavelength and the second optical modulator is configured to apply amplitude modulation to the laser light at the second wavelength to form second laser light pulses at the second wavelength. The controller is operative to determine at least one of a first compensating pulse shape for the first laser light pulses or a second compensating pulse shape for the second laser light pulses. The at least one drive signal is configured to cause at least one of the first optical modulator to apply amplitude modulation to form the first laser light pulses having the first compensating pulse shape or the second optical modulator to apply amplitude modulation to form the second laser light pulses having the second compensating pulse shape.

Forming the first laser light pulses and the second laser light pulses having a compensating pulse shape may enable the optical pulse source to compensate for pulse shape perturbations introduced by the optical amplification apparatus and/or the optical frequency conversion apparatus, which may advantageously enable the optical pulse source to form output laser light pulses having a target pulse shape independent of such pulse shape perturbations.

In an embodiment, the optical detector is configured to detect a pulse shape of a laser light pulse output from the optical frequency conversion apparatus.

In an embodiment, the optical detector is configured to detect a pulse shape of a laser light pulse output from the optical amplification apparatus.

In an embodiment, the target pulse shape is one of a square pulse or a Gaussian pulse.

In an embodiment, the at least one drive signal is further configured to cause the optical modulation apparatus to apply amplitude modulation to form first laser light pulses having a pulse duration of up to 1 ms and a pulse repetition rate in a range 0.1 kHz to 1 MHz.

In an embodiment, the first laser light pulses have a pulse duration of up to 500 ns.

In an embodiment, the first laser light pulses have a pulse duration in the range 1 ns to 500 ns.

In an embodiment, the optical modulation apparatus is further configured to apply phase modulation to said one of the laser light at the first wavelength or the laser light at the second wavelength. The controller is further operative to determine a phase-offset for the first laser light pulses and to generate the at least one drive signal configured to cause the optical modulation apparatus to additionally apply phase modulation to said one of the laser light at the first wavelength or the laser light at the second wavelength to form the first laser light pulses with the phase-offset between subsequent laser light pulses. This may enable the optical pulse source to form output laser light pulses having a fixed phase-offset between subsequent pulses.

In an embodiment, the optical modulation apparatus comprises a first optical modulator and a second optical modulator. The first optical modulator is configured to apply amplitude modulation to the laser light at the first wavelength to form the first laser light pulses at the first wavelength and the second optical modulator is configured to apply amplitude modulation to the laser light at the second wavelength to form second laser light pulses at the second wavelength. The first optical modulator is further configured to apply phase modulation to the laser light at the first wavelength and the second optical modulator is further configured to apply phase modulation to the laser light at the second wavelength. The controller is further operative to determine a phase-offset for the first laser light pulses and the second laser light pulses. The controller is further operative to generate the at least one drive signal configured to cause the first optical modulator to additionally apply phase modulation to the first laser light at the first wavelength to form the first laser light pulses with the phase-offset between subsequent first laser light pulses and to cause the second optical modulator to additionally apply phase modulation to the laser light at the second wavelength to form the second laser light pulses with the phase-offset between subsequent second laser light pulses. This may enable the optical pulse source to form output laser light pulses having a fixed phase-offset between subsequent pulses.

In an embodiment, the first optical modulator and/or the second optical modulator comprises an acousto-optic modulator, AOM, a Mach-Zehnder electro-optic modulator, MZM-EOM, or a semi-conductor optical amplifier, SOA. An RF signal, e.g. generated by a RF signal generator, can then be provided to the optical modulator as a drive signal, which drives the optical modulator to intensity modulate the cw optical signal, to form the optical pulses. By introducing an appropriate intensity/power envelope in the RF drive signal, the shape of the generated pulses can be configured to at least partly compensate for a non-uniform gain response by a down-stream optical amplifiers and/or optical frequency conversion apparatus. In an embodiment, the RF signal amplitude envelope has a leading edge and a trailing edge and wherein an amplitude of the RF signal increases between the leading edge and the trailing edge to provide that pulses generated by the modulator have an asymmetric shape.

In an embodiment, the optical frequency conversion apparatus is configured to perform the optical frequency conversion by second harmonic generation, SHG, and one of sum frequency generation, SFG, or difference frequency generation, DFG. Use of SHG within the optical frequency generation apparatus advantageously enables efficient suppression of inter-pulse noise in addition to frequency doubling. SHG is intensity dependent, so higher power parts of the first laser light pulses are frequency converted more efficiently and lower power inter-pulse noise is efficiently suppressed.

In an embodiment, the optical frequency conversion apparatus comprises SFG apparatus and SHG apparatus. The SFG apparatus is configured to perform sum frequency generation using the first laser light pulses and the other of the laser light at the first wavelength or the laser light at the second wavelength, to form sum frequency laser light pulses. The SHG apparatus is configured to perform frequency doubling of the sum frequency laser light pulses, to form the output laser light pulses. Advantageously, the SFG apparatus is able to perform sum frequency generation to form sum frequency laser light pulses whether the other of the laser light at the first wavelength or the laser light at the second wavelength comprises cw laser light or second laser light pulses.

In an embodiment, the first wavelength is in a first one of a range 1050 nm to 1110 nm or a range 1535 nm to 1590 nm, the second wavelength is in a second one of the range 1050 nm to 1110 nm or the range 1535 nm to 1590 nm, and the output laser light pulses have a wavelength of one of 317 nm or 318 nm. The optical pulse source may advantageously provide output laser light pulses at wavelengths suitable for Rydberg excitation of Strontium atoms or Caesium atoms.

In an embodiment, the first wavelength is a first one of 1064 nm or 1560 nm, the second wavelength is a second one of 1064 nm or 1560 nm, and the output laser light pulses have a wavelength of 317 nm. The optical pulse source may advantageously provide output laser light pulses at wavelengths suitable for Rydberg excitation of Strontium atoms.

In an embodiment, the first wavelength is a first one of 1072.8 nm or 1550 nm, the second wavelength is a second one of 1072.8 nm or 1550 nm, and the output laser light pulses have a wavelength of 317 nm. The optical pulse source may advantageously provide output laser light pulses at wavelengths suitable for Rydberg excitation of Strontium atoms.

In an embodiment, the first wavelength is a first one of 1078.6 nm or 1550 nm, the second wavelength is a second one of 1078.6 nm or 1550 nm, and the output laser light pulses have a wavelength of 318 nm. The optical pulse source may advantageously provide output laser light pulses at wavelengths suitable for Rydberg excitation of Caesium atoms.

In an embodiment, the optical frequency conversion apparatus comprises first SHG apparatus, SFG apparatus and second SHG apparatus. The first SHG apparatus is configured to perform frequency doubling of the first laser light pulses, to form frequency doubled laser light pulses. The SFG apparatus is configured to perform sum frequency generation using the frequency doubled laser light pulses and the other of the laser light at the first wavelength or the laser light at the second wavelength, to form sum frequency laser light pulses. The second SHG apparatus is configured to perform frequency doubling of the sum frequency laser light pulses, to form the output laser light pulses. Advantageously, the SFG apparatus is able to perform sum frequency generation to form sum frequency laser light pulses whether the other of the laser light at the first wavelength or the laser light at the second wavelength comprises cw laser light or second laser light pulses.

In an embodiment, the first wavelength is a first one of 1566 nm or 1966 nm, the second wavelength is a second one of 1566 nm or 1966 nm, and the output laser light pulses have a wavelength of 302 nm. The optical pulse source may advantageously provide output laser light pulses at wavelengths suitable for Rydberg excitation of Ytterbium atoms.

In an embodiment, the first wavelength is a first one of 1559 nm or 1970 nm, the second wavelength is a second one of 1559 nm or 1970 nm, and the output laser light pulses have a wavelength of 302 nm. The optical pulse source may advantageously provide output laser light pulses at wavelengths suitable for Rydberg excitation of Ytterbium atoms.

In an embodiment, the optical frequency conversion apparatus comprises first SHG apparatus, DFG apparatus and second SHG apparatus. The first SHG apparatus is configured to perform frequency doubling of the first laser light pulses, to form frequency doubled laser light pulses. The DFG apparatus is configured to perform difference frequency generation using the frequency doubled laser light pulses and the other of the laser light at the first wavelength or the laser light at the second wavelength, to form difference frequency laser light pulses. The second SHG apparatus is configured to perform frequency doubling of the difference frequency laser light pulses, to form the output laser light pulses. Advantageously, the DFG apparatus is able to perform difference frequency generation to form difference frequency laser light pulses whether the other of the laser light at the first wavelength or the laser light at the second wavelength comprises cw laser light or second laser light pulses.

In an embodiment, the first wavelength is a first one of 1560 nm or 1092 nm, the second wavelength is a second one of 1560 nm or 1092 nm, and the output laser light pulses have a wavelength of 420 nm. The optical pulse source may advantageously provide output laser light pulses at wavelengths suitable for Rydberg excitation of Rubidium atoms.

Corresponding embodiments and advantages apply also to the optical system for Rydberg excitation and the method of forming optical pulses described below.

A second aspect provides an optical system for Rydberg excitation, the optical system comprising an optical pulse source and an excitation chamber. The optical pulse source comprises a first laser, a second laser, optical modulation apparatus, optical amplification apparatus and optical frequency conversion apparatus. The first laser is configured to output laser light at a first wavelength. The second laser is configured to output laser light at a second wavelength, different to the first wavelength. The optical modulation apparatus is configured to apply amplitude modulation to a first one of the laser light at the first wavelength or the laser light at the second wavelength to form first laser light pulses. The optical amplification apparatus is configured to amplify the first laser light pulses and a second one of the laser light at the first wavelength or the laser light at the second wavelength. The optical frequency conversion apparatus is configured to perform optical frequency conversion using the first laser light pulses and the second one of the laser light at the first wavelength or the laser light at the second wavelength to form output laser light pulses at a third wavelength. The third wavelength is shorter than the first wavelength and the second wavelength.

A third aspect provides a method of generating laser light pulses. The method comprises generating laser light at a first wavelength and generating laser light at a second wavelength, different to the first wavelength. The method further comprises applying amplitude modulation to a first one of the laser light at the first wavelength or the laser light at the second wavelength to form first laser light pulses. The method further comprises amplifying the first laser light pulses and a second one of the laser light at the first wavelength or the laser light at the second wavelength. The method further comprises performing optical frequency conversion using the first laser light pulses and the second one of the laser light at the first wavelength or the laser light at the second wavelength to form output laser light pulses at a third wavelength, shorter than the first wavelength and the second wavelength.

Embodiments of the invention will now be described, by way of example only, with reference to the accompanying drawings.

### BRIEF DESCRIPTION OF THE DRAWINGS

FIGS. 1 to 9 are block diagrams illustrating embodiments of an optical pulse source;

FIGS. 10 to 13 are block diagrams illustrating embodiments of an optical pulse source and embodiments of an optical system for Rydberg excitation; and

FIG. 14 is a flowchart illustrating an embodiment of a method of forming an optical pulse.

### DETAILED DESCRIPTION

The same reference numbers are used for corresponding features in different embodiments.

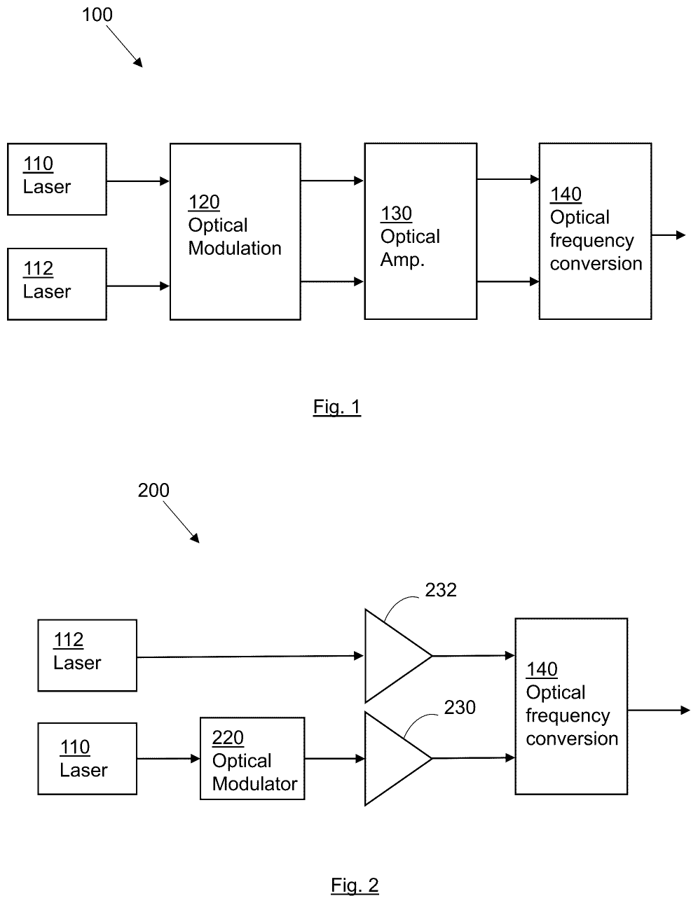

Referring to FIG. 1, an embodiment provides an optical pulse source 100 comprising a first laser 110, a second laser 112, optical modulation apparatus 120, optical amplification apparatus 130 and optical frequency conversion apparatus 140.

The first laser 110 is configured to output laser light at a first wavelength. The second laser 112 is configured to output laser light at a second wavelength, different to the first wavelength. The optical modulation apparatus 120 is configured to apply amplitude modulation to a first one of the laser light at the first wavelength or the laser light at the second wavelength to form first laser light pulses. The optical amplification apparatus 130 is configured to amplify the first laser light pulses and a second one of the laser light at the first wavelength or the laser light at the second wavelength. The optical frequency conversion apparatus 140 is configured to perform optical frequency conversion using the first laser light pulses and the second one of the laser light at the first wavelength or the laser light at the second wavelength to form output laser light pulses at a third wavelength. The third wavelength is shorter than the first wavelength and the second wavelength.

An embodiment provides an optical pulse source 200 as shown in FIG. 2. In this embodiment, the optical modulation apparatus comprises a first optical modulator 220, for example an acousto-optic modulator, AOM, configured to apply amplitude modulation to the laser light at the first wavelength. The optical amplification apparatus comprises a first optical amplifier 230 configured to amplify the first laser light pulses and a second optical amplifier 232 configured to amplify the laser light at the second one of the laser light at the first wavelength or the laser light at the second wavelength.

In an embodiment, the first optical amplifier 230 is configured to be continuously pumped. The first optical amplifier may, for example, be one of an Erbium-doped fibre amplifier, EDFA, a Ytterbium-doped fibre amplifier, YDFA, a Thulium-doped fibre amplifier, TDFA, or a Holmium-doped fibre amplifier, HDFA. Selection of which of these types of optical amplifier will depend upon the first wavelength of the laser light generated by the first laser 110, as will be well known to the person skilled in the art.

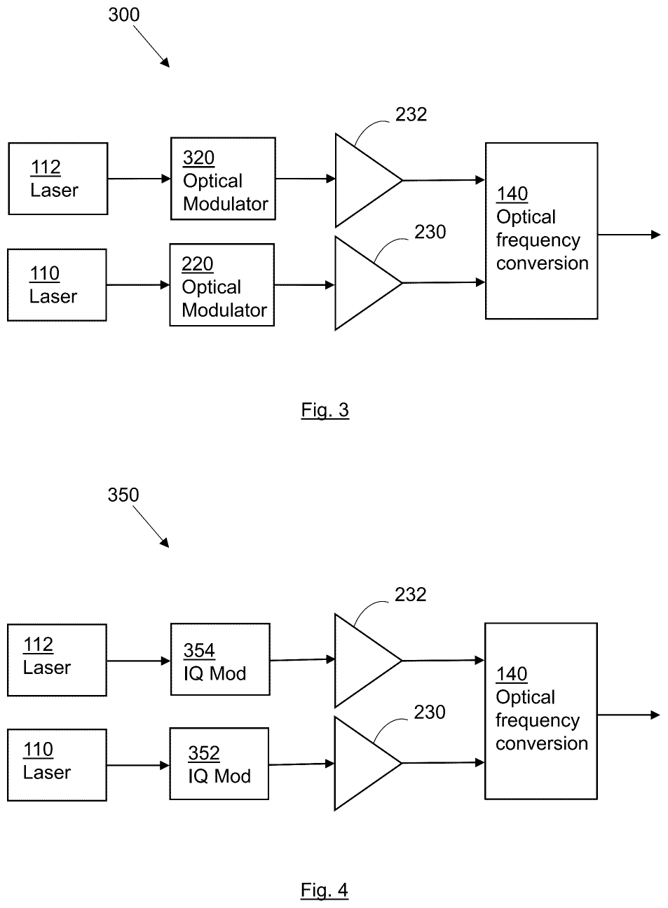

An embodiment provides an optical pulse source 300 as shown in FIG. 3. In this embodiment, the optical modulation apparatus comprises a first optical modulator 220 and a second optical modulator 320. For example, the first and second optical modulators 220, 320 may be AOMs. The first optical modulator 220 is configured to apply amplitude modulation to the laser light at the first wavelength to form the first laser light pulses at the first wavelength. The second optical modulator 320 is configured to apply amplitude modulation to the laser light at the second wavelength to form second laser light pulses at the second wavelength.

The optical amplification apparatus comprises a first optical amplifier 230 configured to amplify the first laser light pulses and a second optical amplifier 232 configured to amplify the second laser light pulses.

In an embodiment, the first optical amplifier 230 is configured to be continuously pumped and the second optical amplifier 232 is configured to be continuously pumped. Each of the optical amplifiers may, for example, be one of an Erbium-doped fibre amplifier, EDFA, a Ytterbium-doped fibre amplifier, YDFA, a Thulium-doped fibre amplifier, TDFA, or a Holmium-doped fibre amplifier, HDFA. Selection of which of these types of optical amplifier will depend upon the wavelengths of the laser light generated by each of the first laser and the second laser, as will be well known to the person skilled in the art.

An embodiment provides an optical pulse source 350 as shown in FIG. 4, in which the optical modulation apparatus is further configured to apply phase modulation to said one of the laser light at the first wavelength or the laser light at the second wavelength. In the embodiment illustrated in FIG. 4, the optical modulation apparatus comprises a first IQ modulator 352 and a second IQ modulator 354. The first IQ modulator is configured to apply amplitude modulation and phase modulation to the laser light at the first wavelength to form first laser light pulses at the first wavelength. The second IQ modulator is configured to apply amplitude modulation and phase modulation to the laser light at the second wavelength to form second laser light pulses at the second wavelength.

The optical modulation apparatus of this embodiment may alternatively comprise a first AOM, a first electro-optic modulator, EOM, a second AOM and a second EOM. The first AOM is configured to apply amplitude modulation to the laser light at the first wavelength to form first laser light pulses at the first wavelength and the first EOM is configured to apply phase modulation to the first laser light pulses. The second AOM is configured to apply amplitude modulation to the laser light at the second wavelength to form second laser light pulses at the second wavelength and the second EOM is configured to apply phase modulation to the second laser light pulses.

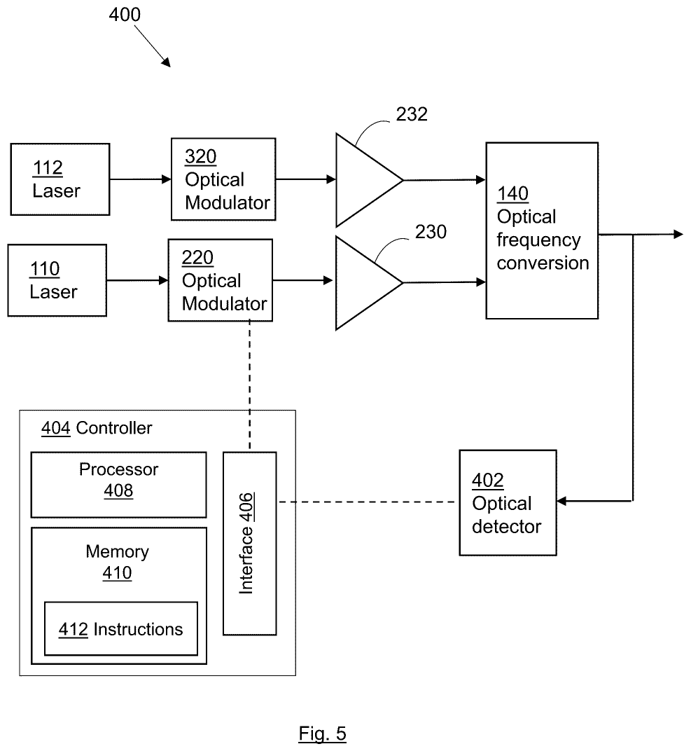

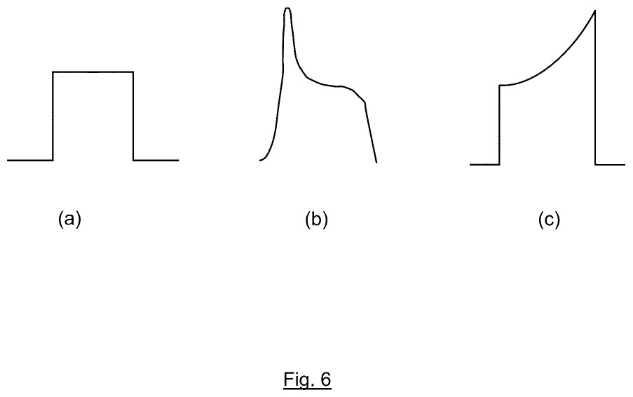

Referring to FIGS. 5 and 6, an embodiment provides an optical pulse source 400 which further comprises output pulse control apparatus comprising an optical detector 402 and a controller 404.

The optical detector is configured to detect a pulse shape of a laser light pulse output from the optical frequency conversion apparatus 140 and to generate an output signal indicative of the detected pulse shape. The controller comprises interface circuitry 406, a processor 408 and memory 410. The memory comprises instructions 412 executable by the processor whereby the controller is operative as follows. The controller is operative to receive an output signal indicative of a detected pulse shape from the optical detector.

The controller is operative to determine a difference between the detected pulse shape and a target pulse shape. The controller is operative to determine a compensating pulse shape for the first laser light pulses. The compensating pulse shape is configured to at least partly compensate for the difference between the detected pulse shape and the target pulse shape. The compensating pulse shape thus compensates for pulse shape perturbations introduced by the optical amplification apparatus and/or the optical frequency conversion apparatus.

For example, if the target pulse shape is a square pulse as shown in FIG. 6(a) and the detected pulse shape is approximately square with an initial peak (i.e. with a pulse shape perturbation), as shown in FIG. 6(b), then a compensating pulse generally having the pulse shape shown in FIG. 6(c) may be used to compensate for the difference, so that square output pulses are formed in which the pulse perturbation is at least partly compensated for.

The controller is operative to generate at least one drive signal for the optical modulation apparatus, in this example a drive signal for the first optical modulator 220. The drive signal is configured to cause the first optical modulator to apply amplitude modulation to form first laser light pulses having the compensating pulse shape.

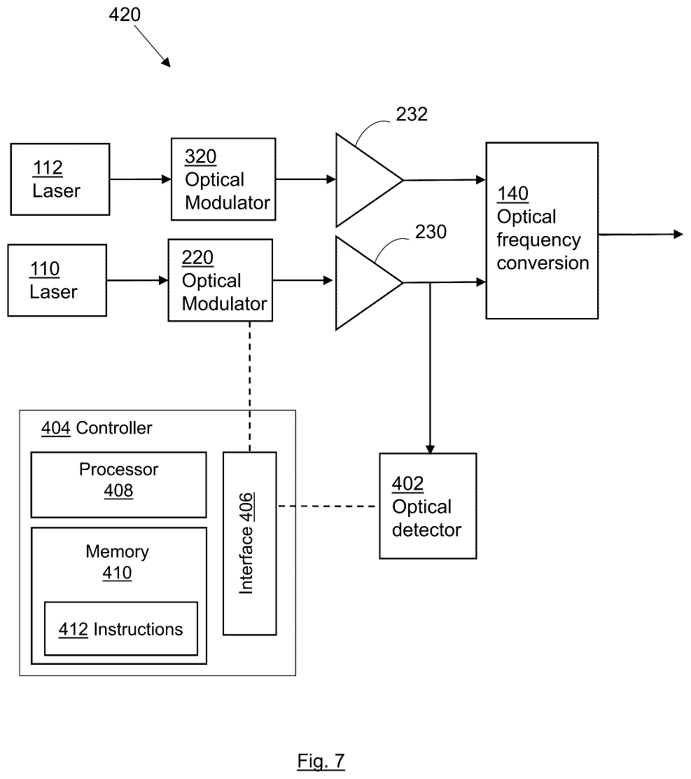

Alternatively, as in the embodiment of the optical pulse source 420 shown in FIG. 7, the optical detector is configured to detect a pulse shape of a laser light pulse output from the optical amplification apparatus, for example the laser light pulse output from the first optical amplifier 230.

In an embodiment, the at least one drive signal is further configured to cause the optical modulation apparatus to apply amplitude modulation to form first laser light pulses having a pulse duration of up to 1 ms and a pulse repetition rate in the range 0.1 kHz to 1 MHz.

In an embodiment, the first laser light pulses have a pulse duration of up to 500 ns.

In an embodiment, the first laser light pulses have a pulse duration in the range 1 ns to 500 ns. In an embodiment, the controller is operative to generate a drive signal for the first optical modulator 220 and the second optical modulator 320 to cause the optical modulators to modulate the laser light at the first wavelength and the laser light at the second wavelength respectively to form first laser light pulses and second laser light pulses that are square pulses having a 150 ns pulse duration and a pulse repetition rate of 1 kHz. Using the same drive signal advantageously means that the first laser light pulses and the second laser light pulses are synchronized.

The first optical amplifier is configured to be continuously pumped to amplify the first laser light pulses to an average power of at least 3 mW and the second optical amplifier is configured to be continuously pumped to amplify the second laser light pulses to an average power of at least 3 mW. Pumping the optical amplifiers to amplify to an average power of at least 3 mw will result in the first laser light pulses and the second laser light pulses being amplified to pulse peak powers of 20 W, since 20 W×150 ns×1 kHz=3 mW. The first laser light pulses and the second laser light pulses output from the respective optical amplifiers are therefore 20 W peak power, square pulses of 150 ns pulse duration and 1 kHz pulse repetition rate but the optical amplifiers are only required to be continuously pumped to amplify to a relatively low average power of 3 mW.

In an embodiment, the controller 404 is operative to determine a first compensating pulse shape for the first laser light pulses and a second compensating pulse shape for the second laser light pulses. The controller is operative to generate a first drive signal for the first optical modulator 220 and a second drive signal for the second optical modulator 320. The first drive signal is configured to cause the first optical modulator to apply amplitude modulation to form the first laser light pulses having the first compensating pulse shape. The second drive signal is configured to cause the second optical modulator to apply amplitude modulation to form the second laser light pulses having the second compensating pulse shape.

In an embodiment, the target pulse shape is one of a square pulse or a Gaussian pulse.

In an embodiment, the controller 404 is further operative to determine a phase-offset for the first laser light pulses. The controller is additionally operative to generate the at least one drive signal configured to cause the optical modulation apparatus to additionally apply phase modulation to said one of the laser light at the first wavelength or the laser light at the second wavelength to form the first laser light pulses with the phase-offset between subsequent laser light pulses.

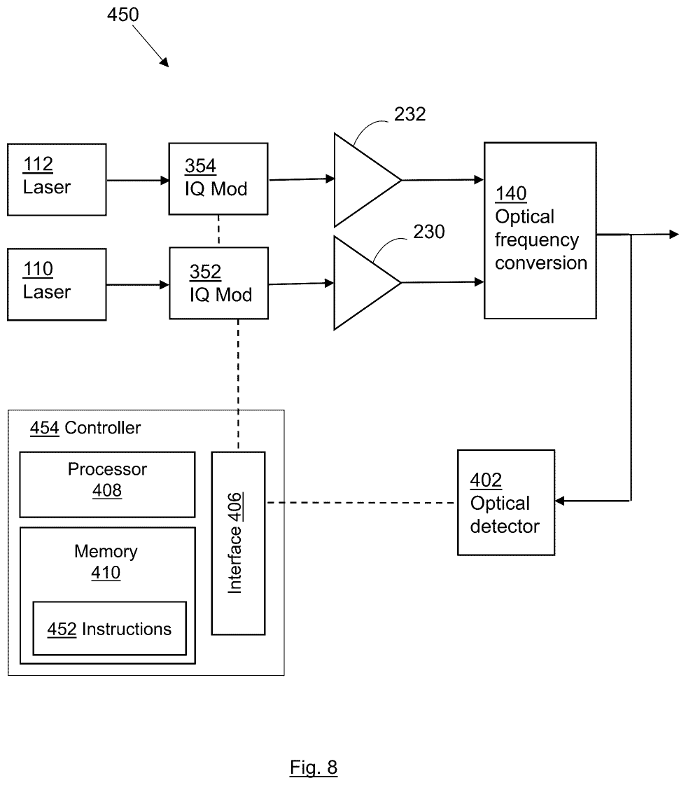

FIG. 8 shows an optical pulse source 450 according to an embodiment in which the first optical modulator is further configured to apply phase modulation to the laser light at the first wavelength and the second optical modulator is further configured to apply phase modulation to the laser light at the second wavelength. For example, the first optical modulator is a first IQ modulator 352 and the second optical modulator is a second IQ modulator 354.

The controller 454 of this embodiment is further operative to determine a phase-offset for the first laser light pulses and the second laser light pulses. The controller is operative to generate at least one drive signal configured to cause the first optical modulator to additionally apply phase modulation to the laser light at the first wavelength to form the first laser light pulses with the phase-offset between subsequent first laser light pulses and to cause the second optical modulator to additionally apply phase modulation to the laser light at the second wavelength to form the second laser light pulses with the phase-offset between subsequent second laser light pulses.

Alternatively, the optical detector may be configured to detect a pulse shape of a laser light pulse output from the optical amplification apparatus, for example the laser light pulse output from the first optical amplifier 230.

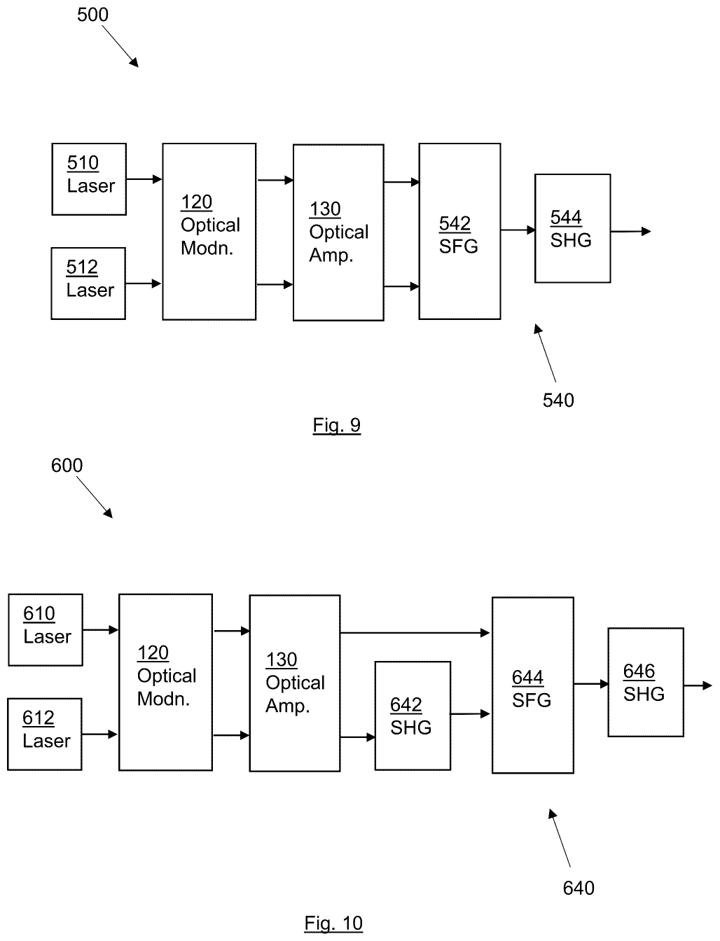

FIG. 9 shows an optical pulse source 500 according to an embodiment in which the optical modulation apparatus 540 comprises sum frequency generation, SFG, apparatus 542 and second harmonic generation, SHG, apparatus 544. The SFG apparatus 542 is configured to perform sum frequency generation using the first laser light pul-ses and the other of the laser light at the first wavelength or the laser light at the second wavelength, to form sum frequency laser light pulses. The SHG apparatus 544 is configured to perform frequency doubling of the sum frequency laser light pulses, to form the output laser light pulses.

In an embodiment, the first laser 510 is configured to output laser light at a first wavelength in a first one of a range 1050 nm to 1110 nm or a range 1535 nm to 1590 nm. The second laser 512 is configured to output laser light at second wavelength in a second one of the range 1050 nm to 1110 nm or the range 1535 nm to 1590 nm. The output laser light pulses have a wavelength of one of 317 nm or 318 nm.

In an embodiment, the first laser 510 is configured to output laser light at a first one of 1064 nm or 1560 nm. The second laser 512 is configured to output laser light at a second one of 1064 nm or 1560 nm. The output laser light pulses have a wavelength of 317 nm.

In an embodiment, the first laser 510 is configured to output laser light at a first one of 1072.8 nm or 1550 nm. The second laser 512 is configured to output laser light at second one of 1072.8 nm or 1550 nm. The output laser light pulses have a wavelength of 317 nm.

In an embodiment, the first laser 510 is configured to output laser light at a first one of 1078.6 nm or 1550 nm. The second laser 512 is configured to output laser light at second one of 1078.6 nm or 1550 nm. The output laser light pulses have a wavelength of 318 nm.

FIG. 10 shows an optical pulse source 600 according to an embodiment in which the optical frequency conversion apparatus 640 comprises first SHG apparatus 642, SFG apparatus 644 and second SHG apparatus 646. The first SHG apparatus 642 is configured to perform frequency doubling of the first laser light pulses, to form frequency doubled laser light pulses. The SFG apparatus 644 is configured to perform sum frequency generation using the frequency doubled laser light pulses and the other of the laser light at the first wavelength or the laser light at the second wavelength, to form sum frequency laser light pulses. The second SHG apparatus 646 is configured to perform frequency doubling of the sum frequency laser light pulses, to form the output laser light pulses.

In an embodiment, the first laser 610 is configured to output laser light at a first one of 1566 nm or 1966 nm. The second laser 612 is configured to output laser light at second one of 1566 nm or 1966 nm. The output laser light pulses have a wavelength of 302 nm.

In an embodiment, the first laser 610 is configured to output laser light at a first one of 1559 nm or 1970 nm. The second laser 612 is configured to output laser light at second one of 1559 nm or 1970 nm. The output laser light pulses have a wavelength of 302 nm.

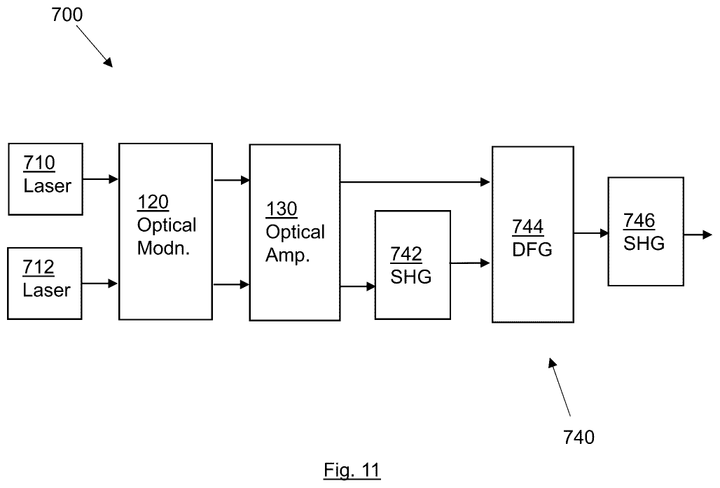

FIG. 11 shows an optical pulse source 700 according to an embodiment in which the optical frequency conversion apparatus 740 comprises first SHG apparatus 742, DFG apparatus 744 and second SHG apparatus 746. The first SHG apparatus 742 is configured to perform frequency doubling of the first laser light pulses, to form frequency doubled laser light pulses. The DFG apparatus 744 is configured to perform difference frequency generation using the frequency doubled laser light pulses and the other of the laser light at the first wavelength or the laser light at the second wavelength, to form difference frequency laser light pulses. The second SHG apparatus 746 is configured to perform frequency doubling of the difference frequency laser light pulses, to form the output laser light pulses.

In an embodiment, the first laser 710 is configured to output laser light at a first one of 1560 nm or 1092 nm. The second laser 712 is configured to output laser light at second one of 1560 nm or 1092 nm. The output laser light pulses have a wavelength of 420 nm.

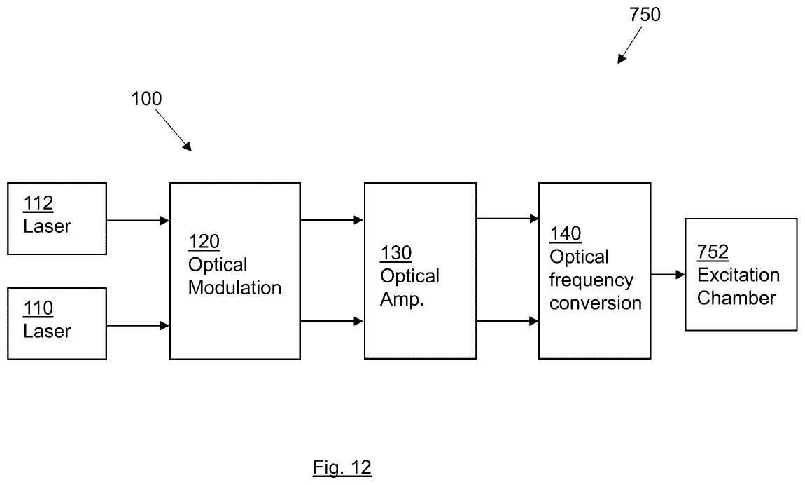

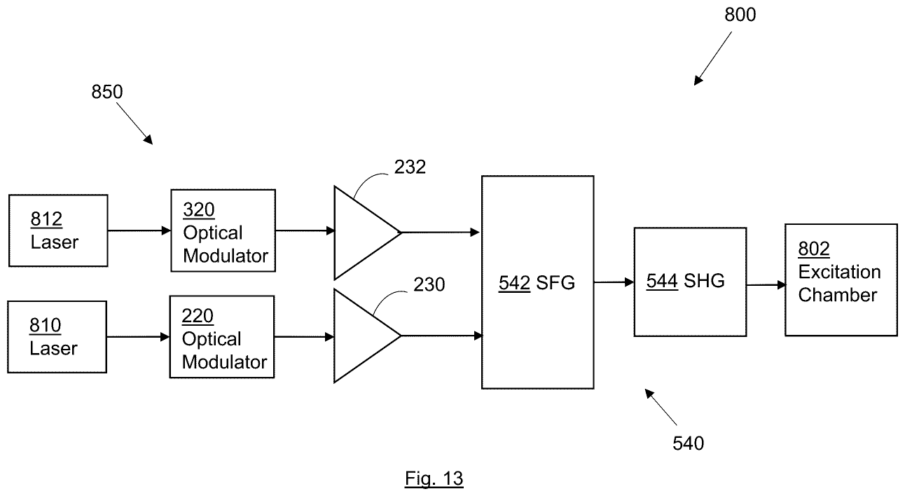

Referring to FIG. 12, an embodiment provides an optical system 750 for Rydberg excitation. The optical system 750 comprises an optical pulse source 100 as described above and an excitation chamber 752.

Referring to FIG. 13, an embodiment provides an optical system 800 for Rydberg excitation. The optical system 800 comprises an optical pulse source 850 and an excitation chamber 802.

The optical pulse source 850 comprises a first laser 810, a second laser 812, optical modulation apparatus 220, 320, optical amplification apparatus 230, 232 and optical frequency conversion apparatus 540.

The first laser 810 is configured to output laser light at a first wavelength. The second laser 812 is configured to output laser light at a second wavelength, different to the first wavelength.

The optical modulation apparatus comprises a first optical modulator 220 and a second optical modulator 320. The first optical modulator 220 is configured to apply amplitude modulation to the laser light at the first wavelength to form first laser light pulses at the first wavelength. The second optical modulator 320 is configured to apply amplitude modulation to the laser light at the second wavelength to form second laser light pulses at the second wavelength.

The optical amplification apparatus comprises a first optical amplifier 230 configured to amplify the first laser light pulses and a second optical amplifier 232 configured to amplify the second laser light pulses.

The optical frequency conversion apparatus 540 is configured to perform optical frequency conversion using the first laser light pulses and the second laser light pulses to form output laser light pulses at a third wavelength. The third wavelength is shorter than the first wavelength and the second wavelength. The optical frequency conversion apparatus 540 comprises sum frequency generation, SFG, apparatus 542 and second harmonic generation, SHG, apparatus 544. The SFG apparatus 542 is configured to perform sum frequency generation using the first laser light pulses and the other of the laser light at the first wavelength or the laser light at the second wavelength, to form sum frequency laser light pulses. The SHG apparatus 544 is configured to perform frequency doubling of the sum frequency laser light pulses, to form the output laser light pulses.

In an embodiment, the first laser 810 is configured to output laser light at a first wavelength in a first one of a range 1050 nm to 1110 nm or a range 1535 nm to 1590 nm. The second laser 812 is configured to output laser light at second wavelength in a second one of the range 1050 nm to 1110 nm or the range 1535 nm to 1590 nm. The output laser light pulses have a wavelength of one of 317 nm or 318 nm.

In an embodiment, the first laser 810 is configured to output laser light at a first one of 1064 nm or 1560 nm. The second laser 812 is configured to output laser light at second one of 1064 nm or 1560 nm. The output laser light pulses have a wavelength of 317 nm. The optical system 800 of this embodiment may therefore be used for Rydberg excitation of Strontium, Sr, atoms.

In an embodiment, the first laser 810 is configured to output laser light at a first one of 1072.8 nm or 1550 nm. The second laser 812 is configured to output laser light at second one of 1072.8 nm or 1550 nm. The output laser light pulses have a wavelength of 317 nm. The optical system 800 of this embodiment may therefore be used for Rydberg excitation of Strontium, Sr, atoms.

In an embodiment, the first laser 810 is configured to output laser light at a first one of 1078.6 nm or 1550 nm. The second laser 812 is configured to output laser light at second one of 1078.6 nm or 1550 nm. The output laser light pulses have a wavelength of 318 nm. The optical system 800 of this embodiment may therefore be used for Rydberg excitation of Caesium, Cs, atoms.

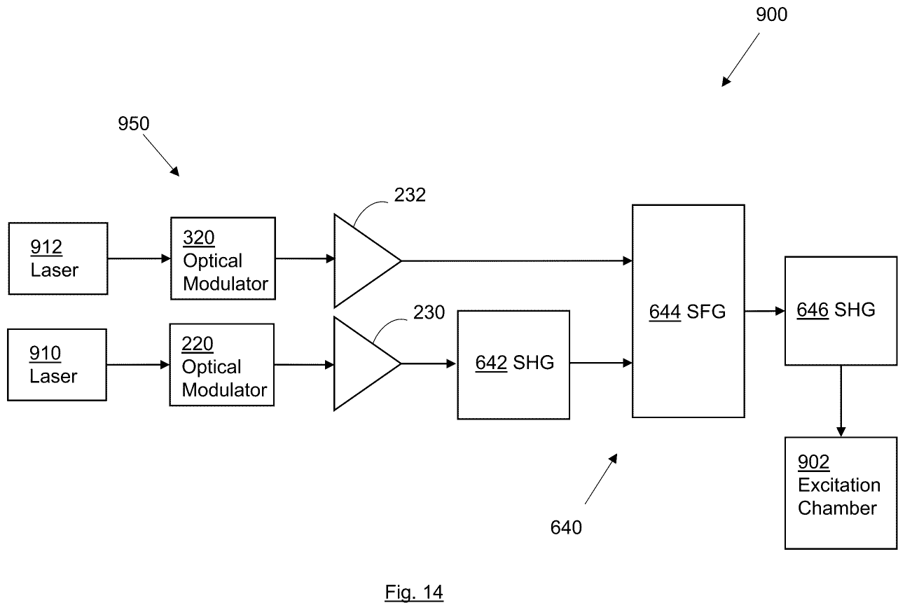

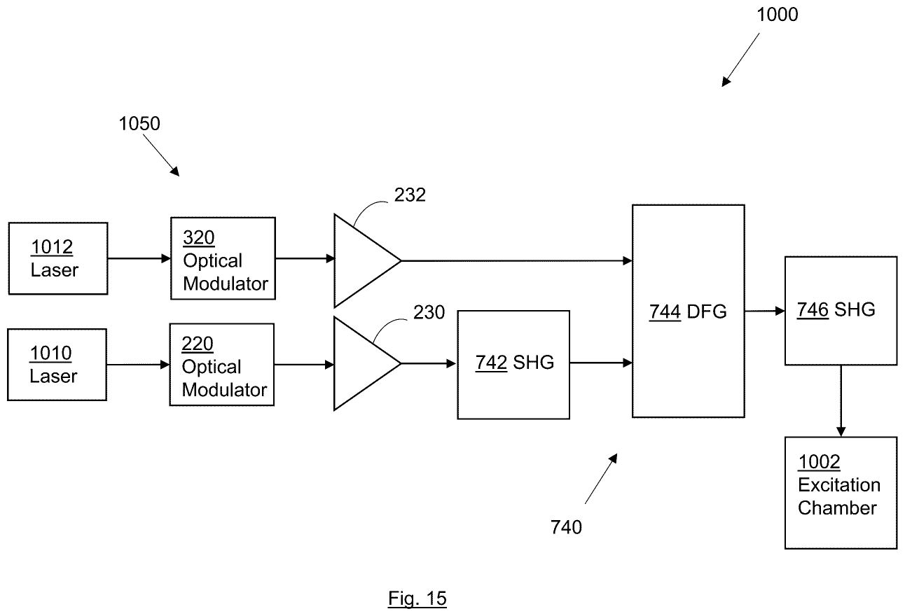

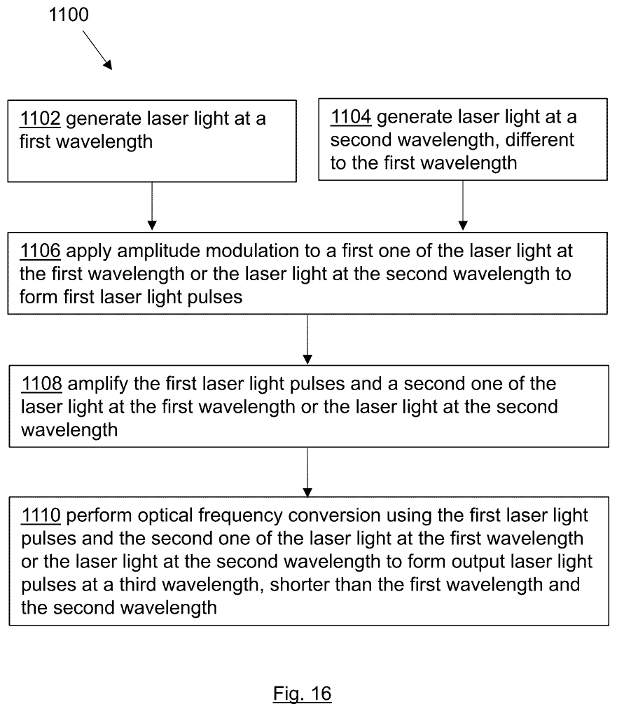

Referring to FIG. 14, an embodiment provides an optical system 900 for Rydberg excitation. The optical system 900 comprises an optical pulse source 950 and an excitation chamber 902.

The optical pulse source 950 comprises a first laser 910, a second laser 912, optical modulation apparatus 220, 320, optical amplification apparatus 230, 232 and optical frequency conversion apparatus 640.

The optical modulation apparatus and the optical amplification apparatus are as described above with reference to FIG. 13.

The optical frequency conversion apparatus 640 is configured to perform optical frequency conversion using the first laser light pulses and the second laser light pulses to form output laser light pulses at a third wavelength. The third wavelength is shorter than the first wavelength and the second wavelength. The optical frequency conversion apparatus 640 comprises first SHG apparatus 642, SFG apparatus 644 and second SHG apparatus 646. The first SHG apparatus 642 is configured to perform frequency doubling of the first laser light pulses, to form frequency doubled laser light pulses. The SFG apparatus 644 is configured to perform sum frequency generation using the frequency doubled laser light pulses and the other of the laser light at the first wavelength or the laser light at the second wavelength, to form sum frequency laser light pulses. The second SHG apparatus 646 is configured to perform frequency doubling of the sum frequency laser light pulses, to form the output laser light pulses.

In an embodiment, the first laser 910 is configured to output laser light at a first one of 1566 nm or 1966 nm. The second laser 912 is configured to output laser light at second one of 1566 nm or 1966 nm. The output laser light pulses have a wavelength of 302 nm. The optical system 900 of this embodiment may therefore be used for Rydberg excitation of Ytterbium, Yb, atoms.

In an embodiment, the first laser 910 is configured to output laser light at a first one of 1559 nm or 1970 nm. The second laser 912 is configured to output laser light at second one of 1559 nm or 1970 nm. The output laser light pulses have a wavelength of 302 nm. The optical system 900 of this embodiment may therefore be used for Rydberg excitation of Ytterbium, Yb, atoms.

Referring to FIG. 15, an embodiment provides an optical system 1000 for Rydberg excitation. The optical system 1000 comprises an optical pulse source 1050 and an excitation chamber 1002.

The optical pulse source 1050 comprises a first laser 1010, a second laser 1012, optical modulation apparatus 220, 320, optical amplification apparatus 230, 232 and optical frequency conversion apparatus 640.

The optical modulation apparatus and the optical amplification apparatus are as described above with reference to FIG. 13.

The optical frequency conversion apparatus 740 is configured to perform optical frequency conversion using the first laser light pulses and the second laser light pulses to form output laser light pulses at a third wavelength. The third wavelength is shorter than the first wavelength and the second wavelength. The optical frequency conversion apparatus 740 comprises first SHG apparatus 742, DFG apparatus 744 and second SHG apparatus 746. The first SHG apparatus 742 is configured to perform frequency doubling of the first laser light pulses, to form frequency doubled laser light pulses. The DFG apparatus 744 is configured to perform difference frequency generation using the frequency doubled laser light pulses and the other of the laser light at the first wavelength or the laser light at the second wavelength, to form difference frequency laser light pulses. The second SHG apparatus 746 is configured to perform frequency doubling of the difference frequency laser light pulses, to form the output laser light pulses.

In an embodiment, the first laser 1010 is configured to output laser light at a first one of 1560 nm or 1092 nm. The second laser 1012 is configured to output laser light at second one of 1560 nm or 1092 nm. The output laser light pulses have a wavelength of 420 nm. The optical system 1000 of this embodiment may therefore be used for Rydberg excitation of Rubidium, Rb, atoms.

Referring to FIG. 16, an embodiment provides a method 1100 of generating laser light pulses. The method comprises generating 1102 laser light at a first wavelength and generating 1104 laser light at a second wavelength, different to the first wavelength. Then applying 1106 amplitude modulation to a first one of the laser light at the first wavelength or the laser light at the second wavelength to form first laser light pulses. The method further comprises amplifying 1108 the first laser light pulses and a second one of the laser light at the first wavelength or the laser light at the second wavelength. Then performing 1110 optical frequency conversion using the first laser light pulses and the second one of the laser light at the first wavelength or the laser light at the second wavelength to form output laser light pulses at a third wavelength, shorter than the first wavelength and the second wavelength.

### ITEMS

1. An optical pulse source (100, 200, 300, 350, 400, 450, 850, 950, 1050) comprising:
a first laser (110, 510, 610, 710, 810, 910, 1010) configured to output laser light at a first wavelength;
a second laser (112, 512, 612, 712, 812, 912, 1012) configured to output laser light at a second wavelength, different to the first wavelength;
optical modulation apparatus (120, 220, 320, 352, 354) configured to apply amplitude modulation to a first one of the laser light at the first wavelength or the laser light at the second wavelength to form first laser light pulses;
optical amplification apparatus (130, 230, 232) configured to amplify the first laser light pulses and a second one of the laser light at the first wavelength or the laser light at the second wavelength; and
optical frequency conversion apparatus (140, 540, 640, 740) configured to perform optical frequency conversion using the first laser light pulses and the second one of the laser light at the first wavelength or the laser light at the second wavelength to form output laser light pulses at a third wavelength, shorter than the first wavelength and the second wavelength.

2. The optical pulse source of item 1, wherein the optical modulation apparatus comprises a first optical modulator (220, 352) configured to apply amplitude modulation to one of the laser light at the first wavelength or the laser light at the second wavelength to form the first laser light pulses.

3. The optical pulse source of item 2, wherein the optical modulation apparatus further comprises a second optical modulator (320, 354), wherein the first optical modulator (220, 352) is configured to apply amplitude modulation to the laser light at the first wavelength to form the first laser light pulses at the first wavelength and the second optical modulator is configured to apply amplitude modulation to the laser light at the second wavelength to form second laser light pulses at the second wavelength.

4. The optical pulse source of item 3, wherein the optical amplification apparatus comprises a first optical amplifier (230) configured to amplify the first laser light pulses and a second optical amplifier (232) configured to amplify the second laser light pulses.

5. The optical pulse source of any one of items 1 to 4, wherein the optical amplification apparatus is configured to be continuously pumped.

6. The optical pulse source of any one of items 1 to 5, further comprising output pulse control apparatus comprising an optical detector (402) configured to detect a pulse shape of a laser light pulse and to generate an output signal indicative of the detected pulse shape; and
a controller (404, 454) comprising interface circuitry (406), at least one processor (408) and memory (410) comprising instructions (412, 452) executable by said processor whereby the controller is operative to:
   receive an output signal indicative of a detected pulse shape from the optical detector;
   determine a difference between the detected pulse shape and a target pulse shape;
   determine a compensating pulse shape for the first laser light pulses, the compensating pulse shape configured to at least partly compensate for said difference; and generate at least one drive signal for the optical modulation apparatus, the at least one drive signal configured to cause the optical modulation apparatus to apply amplitude modulation to form first laser light pulses having the compensating pulse shape.

7. The optical pulse source of item 6 when dependent on item 3, wherein the controller (404, 454) is operative to determine at least one of a first compensating pulse shape for the first laser light pulses or a second compensating pulse shape for the second laser light pulses, and wherein the at least one drive signal is configured to cause at least one of the first optical modulator to apply amplitude modulation to form the first laser light pulses having the first compensating pulse shape or the second optical modulator to apply amplitude modulation to form the second laser light pulses having the second compensating pulse shape.

8. The optical pulse source of any one of item 6 and item 7, wherein the target pulse shape is one of a square pulse or a Gaussian pulse.

9. The optical pulse source of any one of items 6 to 8, wherein the at least one drive signal is further configured to cause the optical modulation apparatus to apply amplitude modulation to form first laser light pulses having a pulse duration of up to 1 ms, such as up to 500 ns, such as in the range 1 ns to 500 ns, and a pulse repetition rate in a range 0.1 kHz to 1 MHz

10. The optical pulse source of any one of items 1 to 9, wherein the optical modulation apparatus (120, 352, 354) is further configured to apply phase modulation to said one of the laser light at the first wavelength or the laser light at the second wavelength, and wherein the controller (454) is further operative to determine a phase-offset for the first laser light pulses and to generate the at least one drive signal configured to cause the optical modulation apparatus to additionally apply phase modulation to said one of the laser light at the first wavelength or the laser light at the second wavelength to form the first laser light pulses with the phase-offset between subsequent laser light pulses.

11. The optical pulse source of item 10 when dependent on item 3, wherein the first optical modulator (352) is further configured to apply phase modulation to the laser light at the first wavelength and the second optical modulator (354) is further configured to apply phase modulation to the laser light at the second wavelength, and wherein the controller (454) is further operative to determine a phase-offset for the first laser light pulses and the second laser light pulses and to generate the at least one drive signal configured to cause the first optical modulator to additionally apply phase modulation to the laser light at the first wavelength to form the first laser light pulses with the phase-offset between subsequent first laser light pulses and to cause the second optical modulator to additionally apply phase modulation to the laser light at the second wavelength to form the second laser light pulses with the phase-offset between subsequent second laser light pulses.

12. The optical pulse source of any one of items 1 to 11, wherein the optical frequency conversion apparatus (140, 540, 640, 740) is configured to perform the optical frequency conversion by second harmonic generation, SHG, and one of sum frequency generation, SFG, or difference frequency generation, DFG.

13. The optical pulse source of item 12, wherein the optical frequency conversion apparatus (140, 540) comprises:
SFG apparatus (542) configured to perform sum frequency generation using the first laser light pulses and the other of the laser light at the first wavelength or the laser light at the second wavelength, to form sum frequency laser light pulses; and SHG apparatus (544) configured to perform frequency doubling of the sum frequency laser light pulses, to form the output laser light pulses.

14. The optical pulse source of item 13, wherein the first wavelength is in a first one of a range 1050 nm to 1110 nm or a range 1535 nm to 1590 nm, the second wavelength is in a second one of the range 1050 nm to 1110 nm or the range 1535 nm to 1590 nm, and the output laser light pulses have a wavelength of one of 317 nm or 318 nm.

15. The optical pulse source of item 14, wherein the first wavelength is a first one of 1064 nm or 1560 nm, the second wavelength is a second one of 1064 nm or 1560 nm, and the output laser light pulses have a wavelength of 317 nm.

16. The optical pulse source of item 14, wherein the first wavelength is a first one of 1072.8 nm or 1550 nm, the second wavelength is a second one of 1072.8 nm or 1550 nm, and the output laser light pulses have a wavelength of 317 nm.

17. The optical pulse source of item 14, wherein the first wavelength is a first one of 1078.6 nm or 1550 nm, the second wavelength is a second one of 1078.6 nm or 1550 nm, and the output laser light pulses have a wavelength of 318 nm.

18. The optical pulse source of item 12, wherein the optical frequency conversion apparatus (140, 640) comprises:
first SHG apparatus (642) configured to perform frequency doubling of the first laser light pulses, to form frequency doubled laser light pulses;
SFG apparatus (644) configured to perform sum frequency generation using the frequency doubled laser light pulses and the other of the laser light at the first wavelength or the laser light at the second wavelength, to form sum frequency laser light pulses; and
second SHG apparatus (646) configured to perform frequency doubling of the sum frequency laser light pulses, to form the output laser light pulses.

19 The optical pulse source of item 18, wherein the first wavelength is a first one of 1566 nm or 1966 nm, the second wavelength is a second one of 1566 nm or 1966 nm, and the output laser light pulses have a wavelength of 302 nm.

20. The optical pulse source of item 18, wherein the first wavelength is a first one of 1559 nm or 1970 nm, the second wavelength is a second one of 1559 nm or 1970 nm, and the output laser light pulses have a wavelength of 302 nm.

21. The optical pulse source of item 12, wherein the optical frequency conversion apparatus (140, 740) comprises:
first SHG apparatus (742) configured to perform frequency doubling of the first laser light pulses, to form frequency doubled laser light pulses;
DFG apparatus (744) configured to perform difference frequency generation using the frequency doubled laser light pulses and the other of the laser light at the first wavelength or the laser light at the second wavelength, to form difference frequency laser light pulses; and
second SHG apparatus (746) configured to perform frequency doubling of the difference frequency laser light pulses, to form the output laser light pulses.

22. The optical pulse source of item 21, wherein the first wavelength is a first one of 1560 nm or 1092 nm, the second wavelength is a second one of 1560 nm or 1092 nm, and the output laser light pulses have a wavelength of 420 nm.

23. An optical system (750, 800, 900, 1000) for Rydberg excitation, the optical system comprising an optical pulse source (100, 200, 300, 350, 400, 450, 500, 600, 700, 850, 950, 1050) as described in any one of items 1 to 22 and an excitation chamber (752, 802, 902, 1002).

24. A method (1100) of generating laser light pulses, the method comprising:
generating (1102) laser light at a first wavelength;
generating (1104) laser light at a second wavelength, different to the first wavelength;
applying (1106) amplitude modulation to a first one of the laser light at the first wavelength or the laser light at the second wavelength to form first laser light pulses;
amplifying (1108) the first laser light pulses and a second one of the laser light at the first wavelength or the laser light at the second wavelength; and
performing (1110) optical frequency conversion using the first laser light pulses and the second one of the laser light at the first wavelength or the laser light at the second wavelength to form output laser light pulses at a third wavelength, shorter than the first wavelength and the second wavelength.

1. An optical pulse source comprising:
a first laser configured to output laser light at a first wavelength;
a second laser configured to output laser light at a second wavelength, different to the first wavelength;
optical modulation apparatus configured to apply amplitude modulation to a first one of the laser light at the first wavelength or the laser light at the second wavelength to form first laser light pulses;
optical amplification apparatus configured to amplify the first laser light pulses and a second one of the laser light at the first wavelength or the laser light at the second wavelength; and
optical frequency conversion apparatus configured to perform optical frequency conversion using the first laser light pulses and the second one of the laser light at the first wavelength or the laser light at the second wavelength to form output laser light pulses at a third wavelength, shorter than the first wavelength and the second wavelength.

2. The optical pulse source of claim 1, wherein the optical modulation apparatus comprises a first optical modulator configured to apply amplitude modulation to one of the laser light at the first wavelength or the laser light at the second wavelength to form the first laser light pulses.

3. The optical pulse source of claim 2, wherein the optical modulation apparatus further comprises a second optical modulator, wherein the first optical modulator is configured to apply amplitude modulation to the laser light at the first wavelength to form the first laser light pulses at the first wavelength and the second optical modulator is configured to apply amplitude modulation to the laser light at the second wavelength to form second laser light pulses at the second wavelength.

4. The optical pulse source of claim 3, wherein the optical amplification apparatus comprises a first optical amplifier configured to amplify the first laser light pulses and a second optical amplifier configured to amplify the second laser light pulses.

5. The optical pulse source of claim 1, wherein the optical amplification apparatus is configured to be continuously pumped.

6. The optical pulse source of claim 1, further comprising output pulse control apparatus comprising an optical detector configured to detect a pulse shape of a laser light pulse and to generate an output signal indicative of the detected pulse shape; and
a controller comprising interface circuitry, at least one processor and memory comprising instructions executable by said processor whereby the controller is operative to receive an output signal indicative of a detected pulse shape from the optical detector.

7. The optical pulse source of claim 6, wherein the controller is operative to determine at least one of a first compensating pulse shape for the first laser light pulses or a second compensating pulse shape for the second laser light pulses.

8. The optical pulse source of claim 6, wherein the target pulse shape is one of a square pulse or a Gaussian pulse.

9. The optical pulse source of claim 6, wherein the controller is operative to generate at least one drive signal configured to cause the optical modulation apparatus to apply amplitude modulation to form first laser light pulses having a pulse duration of up to 1 ms, and a pulse repetition rate in a range 0.1 kHz to 1 MHz.

10. The optical pulse source of claim 1, wherein the optical modulation apparatus is further configured to apply phase modulation to said one of the laser light at the first wavelength or the laser light at the second wavelength.

11. The optical pulse source of claim 10,
wherein the optical modulation apparatus comprises:
a first optical modulator configured to apply amplitude modulation to the laser light at the first wavelength to form the first laser light pulses at the first wavelength, and
a second optical modulator configured to apply amplitude modulation to the laser light at the second wavelength to form second laser light pulses at the second wavelength.

12. The optical pulse source of claim 1, wherein the optical frequency conversion apparatus is configured to perform the optical frequency conversion by second harmonic generation, SHG, and one of sum frequency generation, SFG, or difference frequency generation, DFG.

13. The optical pulse source of claim 12, wherein the optical frequency conversion apparatus comprises:
SFG apparatus configured to perform sum frequency generation using the first laser light pulses and the other of the laser light at the first wavelength or the laser light at the second wavelength, to form sum frequency laser light pulses.

14. The optical pulse source of claim 12, wherein the optical frequency conversion apparatus comprises:
first SHG apparatus configured to perform frequency doubling of the first laser light pulses, to form frequency doubled laser light pulses;
SFG apparatus configured to perform sum frequency generation using the frequency doubled laser light pulses and the other of the laser light at the first wavelength or the laser light at the second wavelength, to form sum frequency laser light pulses; and
second SHG apparatus configured to perform frequency doubling of the sum frequency laser light pulses, to form the output laser light pulses.

15. The optical pulse source of claim 12, wherein the optical frequency conversion apparatus comprises:
first SHG apparatus configured to perform frequency doubling of the first laser light pulses, to form frequency doubled laser light pulses;
DFG apparatus configured to perform difference frequency generation using the frequency doubled laser light pulses and the other of the laser light at the first wavelength or the laser light at the second wavelength, to form difference frequency laser light pulses; and
second SHG apparatus configured to perform frequency doubling of the difference frequency laser light pulses, to form the output laser light pulses.

16. An optical system for Rydberg excitation, the optical system comprising an optical pulse source as claimed in claim 1 and an excitation chamber.

17. The optical pulse source of claim 6, wherein the controller is further operative to:
determine a difference between the detected pulse shape and a target pulse shape;
determine a compensating pulse shape for the first laser light pulses, the compensating pulse shape configured to at least partly compensate for said difference; and
generate at least one drive signal for the optical modulation apparatus, the at least one drive signal configured to cause the optical modulation apparatus to apply amplitude modulation to form first laser light pulses having the compensating pulse shape.

18. The optical pulse source of claim 7,
wherein the optical modulation apparatus comprises:
a first optical modulator configured to apply amplitude modulation to the laser light at the first wavelength to form the first laser light pulses at the first wavelength, and
a second optical modulator configured to apply amplitude modulation to the laser light at the second wavelength to form second laser light pulses at the second wavelength,
wherein the controller is operative to generate at least one drive signal configured to cause at least one of the first optical modulator to apply amplitude modulation to form the first laser light pulses having the first compensating pulse shape or the second optical modulator to apply amplitude modulation to form the second laser light pulses having the second compensating pulse shape.

19. The optical pulse source of claim 10, wherein the controller is further operative to determine a phase-offset for the first laser light pulses and to generate the at least one drive signal configured to cause the optical modulation apparatus to additionally apply phase modulation to said one of the laser light at the first wavelength or the laser light at the second wavelength to form the first laser light pulses with the phase-offset between subsequent laser light pulses.

20. The optical pulse source of claim 11, wherein the controller is further operative to determine a phase-offset for the first laser light pulses and the second laser light pulses and to generate the at least one drive signal configured to cause the first optical modulator to additionally apply phase modulation to the laser light at the first wavelength to form the first laser light pulses with the phase-offset between subsequent first laser light pulses and to cause the second optical modulator to additionally apply phase modulation to the laser light at the second wavelength to form the second laser light pulses with the phase-offset between subsequent second laser light pulses.

21. The optical pulse source of claim 13, further comprising SHG apparatus configured to perform frequency doubling of the sum frequency laser light pulses, to form the output laser light pulses.

22. The optical pulse source of claim 11, wherein the first optical modulator is further configured to apply phase modulation to the laser light at the first wavelength and the second optical modulator is further configured to apply phase modulation to the laser light at the second wavelength.
